(19) United States
(12) Patent Application Publication
(10) Pub. No.: US 2007/0221344 A1
(43) Pub. Date: Sep. 27, 2007

(54) DIGITALLY PRINTED SLATS

(75) Inventors: Jason Beach, Ballston Lake, NY (US); James Barss, Porter Corners, NY (US)

Correspondence Address: RADER, FISHMAN & GRAUER PLLC, 39533 WOODWARD AVENUE, SUITE 140, BLOOMFIELD HILLS, MI, 48304-0610, US

(73) Assignee: COMFORTEX CORPORATION

(21) Appl. No.: 11/691,569

(22) Filed: Mar. 27, 2007

Related U.S. Application Data
(60) Provisional application No. 60/786,211, filed on Mar. 27, 2006.

(51) Int. Cl. E06B 3/12

(52) U.S. Cl. 160/236

(57) ABSTRACT

A slat is disclosed that includes a digitally printed pattern upon a surface of the slat. The slat may also include a translucent cap over the pattern where the translucent cap provides the appearance of depth to the digitally printed pattern. Additionally, a method of forming a surface finish is disclosed including digitally printing a pattern on a slat. Another method is disclosed for forming a surface finish that include providing a slat and providing a print head. The method also includes, moving the slat or the print head relative to each other, and digitally printing a pattern on said slat.

### CROSS-REFERENCE TO RELATED APPLICATIONS

This application claims the benefit of U.S. Provisional Application Ser. No. 60/786,211 filed Mar. 27, 2006, which is hereby incorporated by reference in its entirety.

### TECHNCAL FIELD

Described herein are embodiments of digitally printed slats and more particularly, a method for simulating natural surfaces having a visually three-dimensional depth of features.

### BACKGROUND

One popular type of window blind is a Venetian type having a set of vanes held parallel and tilted in coordinated manner by a series of suspending cords The vanes, also called slats, are traditionally made of wood. More recently, vanes of metal and polymers, and composite materials having polymer binders with wood fiber have been developed. Because of the visual appeal and traditional value of wood in these products, the more recent materials, which exhibit other desirable properties like lower cost or greater dimensional stability, nonetheless are expected to mimic wood in appearance. Such mimicry is difficult to achieve; so much so that the phrase ‘plastic woodgrain’ has entered the common lexicon as an example of poor imitation of quality materials. A similar problem exists in the simulation of other natural surfaces that include visible features extending into the depth of the material, for example, stone with large, translucent grains as used in countertops.

In the manufacture of non-wood blinds, many approaches have been used to improve the simulation of wood surfaces on slats. Painting of artificial grain is an ancient art that has been applied even to real woods to simulate the different graining of other more desired species. More recently printing of grains by roller or pad-applied patterns has become a standard, but suffers from repeats in the result, determined by the perimeter of the roller or length of pad. Such repeats can become visible and destroy the illusion of natural variation in a blind made of many long slats, especially if they are cut consecutively from a continuous product. It is also very difficult to continue the illusion of grain or other patterns where the base surface is not a flat one, but includes grooves, waves, or edges that prevent uniform contact with the printing source. Wrapping of pre-printed foils or papers has been used successfully in such cases, by enabling the printing to occur first on a flat film that is then applied to the complex shape of a vane. Wrapping is a costly process, though, and subject to bubbling, tearing, and unnatural appearance at the cut ends of the slats. A special, but even more costly, variant of wrapping is veneering, where the film is a very thin shaving of natural wood, but this can be as expensive as solid wood itself. In composite or polymer slats made by extrusion, a rough approximation of wood graining (or at least color variation) can be attained by including in the extrusion blend darker polymer pellets with higher melt properties that form dark streaks and dots in the surface of lighter base material when they are extruded together. Some printing over pore-like markings can improve the illusion of wood grain based on extruded streaks, but even the depth of this two-step process is not fully convincing.

What is needed is a method to replicate the apparent depth of surface features resulting from sawn and finished wood (or other solid materials with some translucence or porosity), but in a surface treatment that can be applied in a thin top layer to a base material or arbitrary prismatic shape, in continuous production as with extrusion; all at a lower price than solid natural materials or the assembled (wrapped, veneered) processes now available to achieve adequate simulation on base cores.

### BRIEF DESCRIPTION OF THE DRAWINGS

The features and inventive aspects of the present invention will become more apparent from the following detailed description, the appended claims, and the accompanying drawings, of which the following is a brief description:

FIG. 1 is a perspective view of a first embodiment of a blank slat;

FIG. 2 is a cross-sectional view of the blank slat of FIG. 1;

FIG. 3 is a perspective view of a first embodiment of a digitally printed slat showing a woodgrain finish;

FIG. 4 is a perspective view of a second embodiment of a blank slat;

FIG. 5 is a cross-sectional view of the blank slat of FIG. 4;

FIG. 6 is a perspective view of a second embodiment of a digitally printed slat showing a woodgrain finish;

FIG. 7 is a side view of an exemplary embodiment of a first shutter component showing a contoured surface; and

FIG. 8 is a side view of an exemplary embodiment of a second shutter component showing a contoured surface.

### DETAILED DESCRIPTION

Referring now to the drawings, illustrative embodiments are shown in detail. Although the drawings represent the embodiments, the drawings are not necessarily to scale and certain features may be exaggerated to better illustrate and explain an innovative aspect of an embodiment. Further, the embodiments described herein are not intended to be exhaustive or otherwise limit or restrict the invention to the precise form and configuration shown in the drawings and disclosed in the following detailed description.

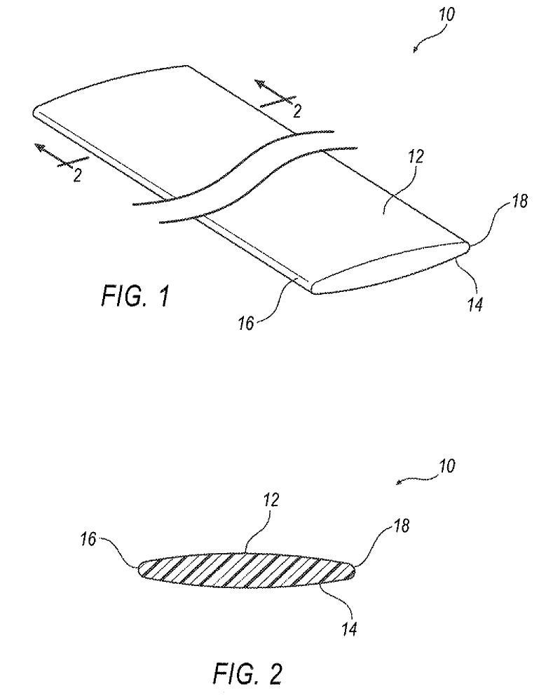

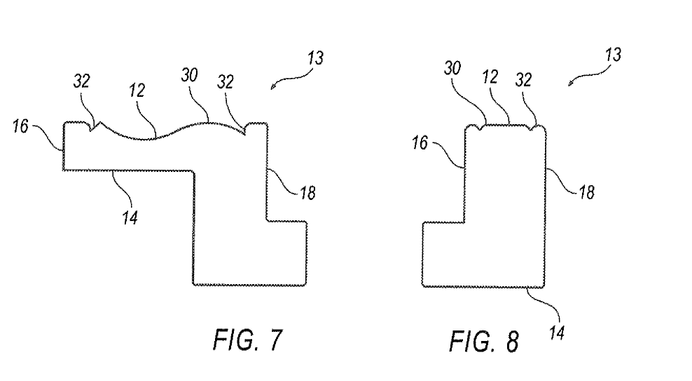

Referring now to FIG. 1, a first embodiment of a composite slat 10 is shown having a blank upper surface 12 and a blank lower surface 14. The upper surface 12 may be formed into any shape including generally straight curved (as shown), and textured to have multiple ridges and contours. The lower surface 14 may also be formed into the same shape as the upper surface 12 or be of any different shape including straight, curved, or textured. FIGS. 7 and 8 are two exemplary embodiments of a shutter component 13 having a complex upper surface 12 for the purpose of this disclosure. FIG. 2 shows a cross-sectional view taken along cross-section line 2-2 in FIG. 1 to better show the curved upper surface 12 and the curved lower surface 14 of the first embodiment. The front face 16 and the rear face 18 may also include a rounded, flat, or contoured shape. The slat 10 may be formed from any synthetic material including a wood-polymer composite allowing printing to the surfaces 12, 14 and faces 16, 18.

The term “print surface” or any variation thereof such as “printing surface” and “printed surface” as used throughout the specification is defined hereinafter to include but is not limited to: providing a pattern, marking, impression, or image to at least one of the upper surface, 12, the lower surface 14, the front face 16, and the rear face 18 by any digital printing device. The term “digital” as used throughout the specification is defined hereinafter to include but is not limited to: an image expressed in numerical form; of or relating to a device that can read, write, or store information that is represented in numerical form; of a circuit or device that represents magnitudes in digits; and a description of data which is stored or transmitted as a sequence of discrete symbols from a finite set, most commonly this means binary data represented using electronic or electromagnetic signals.

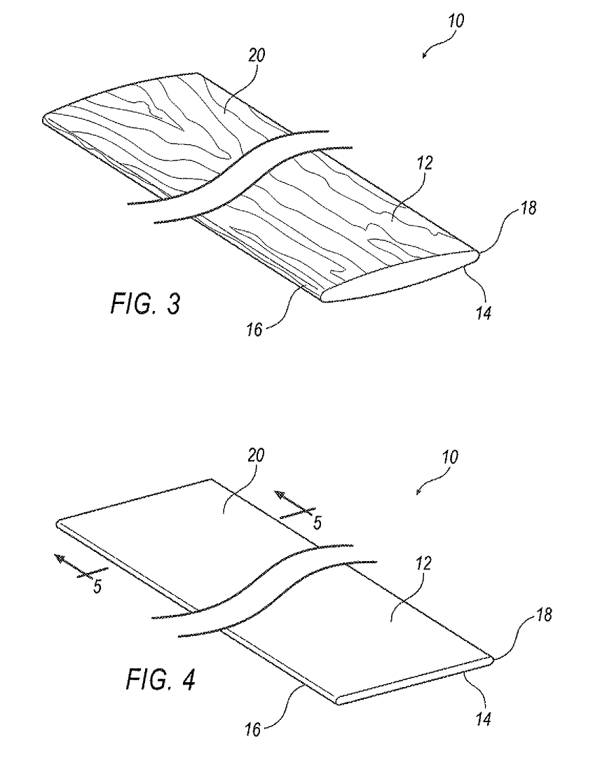

FIG. 3 shows a slat 10 having a simulated natural deep-featured surface 20. The slat 10 includes an imprinted pattern. The pattern is printed using the digital printing method onto a substrate or slat 10, following which a translucent cap material is applied to the pattern to impart an illusion of depth by allowing the imprinted features to be visible while showing their presence immediately under the surface of the product.

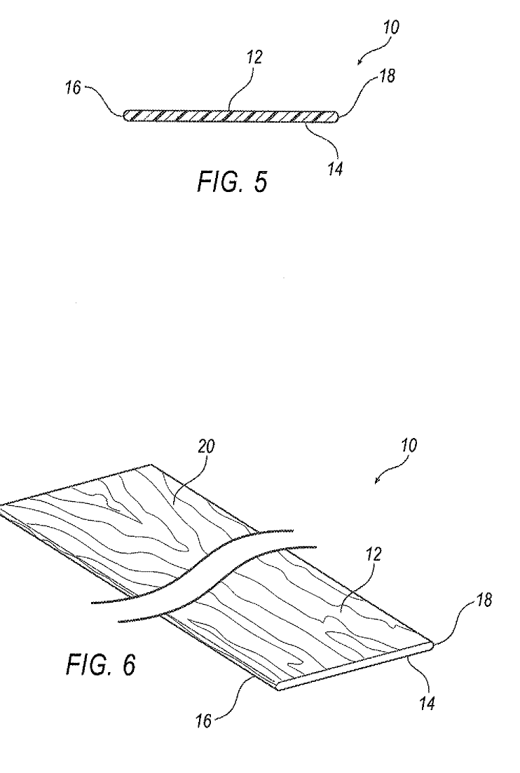

Referring now to FIG. 4, a second embodiment of a composite slat 10 is shown having a blank upper surface 12 and a blank lower surface 14. The upper surface 12 and the lower surface 14 are shown generally flat, but having the faces 16, 18 generally rounded. FIG. 5 shows a cross-sectional view taken along cross-section line 5-5 in FIG. 4 to better show the flat upper surface 12 and the flat lower surface 14 of the second embodiment. The front face 16 and the rear face 18 may also Include a rounded, flat, or contoured shape. The slat 10 may be formed from any synthetic material including a wood-polymer composite allowing printing to be applied to the surfaces 12, 14 and faces 16, 18. FIG. 6 shows a slat 10 having a simulated natural deep-featured surface 20.

The simulated natural deep-featured surface 20 having an open-grained wood or any pattern may be formed by a digital printer of the programmable inkjet or laser that prints directly on the substrate slat 10. An inkjet system uses a print head to shoot miniature droplets of ink on an object. Thus, the inkjets are actually ink deposition systems. A laser system or laser engraving system uses a laser to directly burn a pattern into the substrate. Alternatively, the substrate material may be sensitive to particular frequencies of light and may cure or otherwise change properties when exposed to the laser light to effectuate printing a pattern.

The heads of the digital printer may be moved over the various contours of the substrate or fixed at a predetermined distance away from the substrate. When the heads are fixed, typically at a greater distance away from the substrate, the undulating surfaces of the substrate provide a further blending of the pixels when the patterns are printed by providing a more dispersed pattern. By way of example, the upper surface 12 and the lower surface 14 may be printed generally contemporaneously. At least one digital printer head may be located proximate the upper surface 12 and at least one digital printer head may located proximate the lower surface 14. Further, the digital printer heads may be a fixed distance from the edges when printing or may be rotated up to 180 degrees so that all the edges may be addressed by the printer heads. However, the substrate may be rotated instead of the printer heads as the rotation of the printer heads may disturb tank pressures and the performance of the printer heads.

The slat 10 may be made from any printable material including medium-density fiberboard (MDF) capable of receiving a pattern of dark streaks and dots that resemble the pores of a natural wood or stone. The porosity and roughness of the MDF randomizes and blends the digital pixelation in the pattern. Multiple colors provide shading and a depth variation. The digital printer accurately prints on surfaces that are not perpendicular to the printer, allowing application of grain pattern to complex shapes and their edges. The controlling program makes patterns that combine several sub-patterns of different repeats, or that selects from constantly changing bands within patterns wider than the slat 10, all to extend the period of repeat for a finite pattern to lengths greater than noticeable as repeats in any practical product size.

The slat 10 is then subjected to a coating over of the printed pattern, either by extrusion or liquid application such as by spray, brush, roller, and the like of a thin, translucent cap. In effect this application mimics the process of staining and finishing natural woods over their natural grain. The color cap carries elements of different optical density for mild streaking to enhance the variations.

The primary benefits of the described method include digitally printing the pattern on a curved and contoured surface; digitally printing on a porous substrate surface providing a reduction in pixilation and enhancing the illusion of depth, and controlling the absorption of the digital printer material (such as ink and the like) giving a further illusion of depth. Specifically, when the print surface is slightly porous, a user will not be able to visually see the typical “dots” that are generated by a digital printer. The application of a translucent cap provides a further illusion of depth.

In one example, the core of the slat 10 is MDF, the texture is inked directly thereto using a UV-curable ink by Sunjet Corporation, which is left to migrate slightly into the base material and to merge dot-to-dot into a more continuous pattern. The inked core material is then capped in an extrusion die using ABS/SAN polymer By way of example, the ABS/SAN polymer is used for good scratch resistance. However, any alternative will work including polypropylene and the like.

FIGS. 7 and 8 are exemplary embodiments of the shutter component 13 showing that the surfaces 12, 14, 16, and 18 may be of any shape, contour, or size. The upper surface 12 is shown to have a combination of smooth surfaces 30 and crevasses 32. The process of digitally printing the surfaces 12, 14, 16, and 18 described above is equally applicable to such complex surfaces.

One exemplary process of digitally printing a pattern on a substrate includes printing a top and a bottom profile utilizing two 2.8 inch head clusters stitched together to produce a 5 inch wide print zone. The phrase “stitching together” indicates that the heads are positioned in such a way as to prevent a dead zone (e.g., non-printed area) which is typically accomplished by a slight overlapping of the heads. Additional heads may be added to increase print width as desired. Head clusters are stacked 4 on top and 4 on the bottom (2 heads per cluster) bringing the total number of driven heads to 16. The heads are Spectra/Dimatix Galaxy 80 driven by 2 Spectra/Dimatix Merlin controllers (all available from FUJIFILM Dimatix, Inc. of Santa Clara, Calif.). Voltages to the print heads are varied depending on profile shape and desired pattern. Heads can be loaded with Cyan, Magenta, Yellow and Black (CMYK) inks as well as custom formulated colors. Inks are of a UV curable type as well as UV curable paste. Solvent based inks can also be substituted if the environment and local regulations permit.

In some embodiments, the profiles may be extruded or molded. Further, during manufacturing, the profiles are fed on a conveyor system that passes through the top and bottom print head assemblies. The pattern is then applied to the profile, which is either cured via UV lamp and continues to the extrusion capping head or bypasses UV curing and proceeds directly to the extrusion capping head. The printing assemblies can also be used off-line in a separate process where the profiles are fed through the print heads and collected for future capping.

As will be clear to one skilled in the art, the described embodiments, though having the particular advantages of compactness and convenience, are not the only methods or arrangements that fall within the scope of the present invention. Some exemplary variants would included a) using a pre-extruded substrate slat 10 instead of MDF; b) using non-polymer coatings, e.g., silicone-based caps, or varnishes; c) application to other surfaces like tabletops, car dashboards, etc., d) simulation of non-wood and non-stone surfaces, including unnatural effects that require an illusion of depth in a thin coating; and e) alternately, the grain print may be applied over the translucent cap for a more rustic appearance.

The advantages of the described embodiment include effective simulation of randomized patterns with apparent depth of features in a thin continuous coating having numerous advantages that include: a) low-cost substitution of higher-performance polymer-based window blinds for natural wood products; b) in-line production of wood and other similar depth-demanding patterns; and c) natural looking slats at lower cost than expensive woods with added warp, crack, and stain resistance.

The preceding description has been presented only to illustrate and describe exemplary embodiments of the methods and systems of the present invention. It is not intended to be exhaustive or to limit the invention to any precise form disclosed. It will be understood by those skilled in the art that various changes may be made and equivalents may be substituted for elements thereof without departing from the scope of the invention. In addition, many modifications may be made to adapt a particular situation or material to the teachings of the invention without departing from the essential scope. Therefore, it is intended that the invention not be limited to the particular embodiment disclosed as the best mode contemplated for carrying out this invention, but that the invention will include all embodiments falling within the scope of the claims. The invention may be practiced otherwise than is specifically explained and illustrated without departing from its spirit or scope. The scope of the invention is limited solely by the following claims.

What is claimed is:

1. A slat adapted for use in a window-covering system, comprising:
at least one exterior surface; and
a digitally printed pattern printed directly on said at least one exterior surface of said slat.

2. The slat of claim 1, further comprising:
a translucent cap over said digitally printed pattern, said translucent cap providing the appearance of depth to said digitally printed pattern.

3. The slat of claim 1, wherein said digitally printed pattern is a woodgrain.

4. The slat of claim 1, wherein said pattern is digitally printed by at least one of an inkjet and a laser.

5. The slat of claim 1, wherein said surface is uneven or curved.

6. The slat of claim 1, wherein said slat is extruded.

7. A method of forming a surface finish on a slat adapted for use in a window-covering system, the method comprising:
digitally printing a pattern directly on a surface of said slat.

8. The method of claim 7, further comprising:
providing a translucent cap over said digitally printed pattern, said translucent cap providing the appearance of depth to said digitally printed pattern.

9. The method of claim 7, wherein said pattern simulates woodgrain.

10. The method of claim 7, further comprising:
moving a print head or said slat relative to the other to create said pattern from said print head.

11. The method of claim 7, further comprising:
sequencing said print head to digitally print upon said slat at predetermined locations as said print head and slat are moving relative to each other.

12. The method of claim 7, wherein said digitally printing is performed by at least one of an inkjet and a laser.

13. The method of claim 7, wherein said digital printing is performed on a first surface and a second surface of said slat.

14. The method of claim 7, wherein said slat comprises a first generally flat surface and a second generally flat surface connected by a first generally rounded edge and a second generally rounded edge, said digital printing extending over said first and second generally flat surfaces and said first and second generally rounded edges.

15. The method of claim 7, wherein said slat comprises an uneven or curved surface.

16. A method of forming a surface finish comprising:
providing a slat;
providing at least one print head;
moving said slat or said print head relative to the other; and
digitally printing a pattern on said slat.

17. The method of claim 16, further comprising:
providing a translucent cap over said pattern.

18. The method of claim 16, further comprising:
conveying said slat past said at least one print head to facilitate printing along the length of said slat.

19. The method of claim 16, wherein said slat has at least two sides, said at least one print head is located to print on a first side of said slat, and a second print head is located to print on a second side of said slat.

20. The method of claim 16, wherein said pattern is a woodgrain.
